(19) United States
(12) Patent Application Publication
(10) Pub. No.: US 2025/0042691 A1
(43) Pub. Date: Feb. 6, 2025

(54) SHEET CONVEYANCE DEVICE AND IMAGE FORMING SYSTEM

(71) Applicant: CANON KABUSHIKI KAISHA, Tokyo (JP)

(72) Inventor: AKIRA MATSUMOTO, Ibaraki (JP)

(21) Appl. No.: 18/743,448

(22) Filed: Jun. 14, 2024

(30) Foreign Application Priority Data
Aug. 4, 2023 (JP) 2023-127864

(51) Int. Cl. B65H 79/00

(52) U.S. Cl. CPC B65H 79/00; B65H 2403/53; B65H 2403/92; B65H 2801/03

(57) ABSTRACT

A sheet conveyance device includes a center shaft; a driving portion and a rotatable member. The rotatable member includes an engaging hole to engage with the center shaft, a drive coupling portion disposed on an outer diameter side of the engaging hole and coupled to the driving portion, and a restricting portion disposed on the outer diameter side of the engaging hole and for restricting movement of a moving member. The rotatable member changes a position of the restricting member by being rotated between a first position and a second position rotated from the first position about the center shaft by driving of the driving portion. As viewed in an axial direction of the center shaft, a position of a center of gravity of the rotatable member is positioned in an inner diameter side of an inner diameter surface of the engaging hole.

### FIELD OF THE INVENTION AND RELATED ART

The present invention relates to a sheet conveyance device for conveying a sheet and an image forming system.

In an image forming apparatus and an image forming system such as a printer and a copy machine, in order to form an image on a sheet or to discharge the sheet on which the image is formed, a sheet conveyance device is provided. In such a sheet conveyance device, in case of a sheet jam or in order to perform maintenance, an opening/closing member such as an opening/closing door which openably opens and closes a sheet conveyance passage is provided.

If the opening/closing member is opened while the sheet is being conveyed, it may cause failure of the apparatus, tear of the sheet, etc., therefore, in Japanese Patent Application Laid-Open No. 2018-10074, a configuration in which a lock unit which can lock the opening/closing member is provided is proposed. This lock unit is configured that a lock member is rotated by a solenoid. The lock member is configured to be changeable between a state in which the lock member is engaged with a holder fixed to the opening/closing door and a state in which the lock member is released from the engagement with the holder.

However, in the configuration disclosed in Japanese Patent Application Laid-Open No. 2018-10074, since a distance between a rotation center when the lock member is rotated and a position of a center of gravity of a rotatable member is far apart, when the rotatable member is rotated, moment due to own weight of the lock member is generated. Therefore, drive output of the solenoid which outputs driving force to rotate the lock member needs to be increased, which may lead to an increase in size of the solenoid.

### SUMMARY OF THE INVENTION

An object of the present invention is to provide a sheet conveyance device and an image forming system capable of downsizing a driving portion.

According to an aspect of the present invention, there is provided a sheet conveyance device for conveying a sheet, the sheet conveyance device comprising: a center shaft; a driving portion configured to output a driving force; and a rotatable member provided with an engaging hole configured to engage with the center shaft, a drive coupling portion disposed on an outer diameter side of the engaging hole and coupled to the driving portion, and a restricting portion disposed on the outer diameter side of the engaging hole and configured to restrict movement of a moving member, wherein the rotatable member changes a position of the restricting portion by being rotated between a first position and a second position rotated from the first position about the center shaft by driving of the driving portion, and wherein as viewed in an axial direction of the center shaft, a position of a center of gravity of the rotatable member is positioned in an inner diameter side of an inner diameter surface of the engaging hole.

Further features of the present invention will become apparent from the following description of exemplary embodiments with reference to the attached drawings.

### BRIEF DESCRIPTION OF THE DRAWINGS

FIG. 1 is a schematic view illustrating an inkjet recording system according to an Embodiment 1.

FIG. 2 is a perspective view illustrating a feeding module in a state in which an upper door unit is closed according to the Embodiment 1.

FIG. 3 is a perspective view illustrating the feeding module in a state in which the upper door unit is opened according to the Embodiment 1.

FIG. 4 is a perspective view illustrating a unit lock mechanism of the upper door unit according to the Embodiment 1.

FIG. 5 is a perspective view illustrating a grip and a grip lock mechanism of the unit lock mechanism according to the Embodiment 1.

FIG. 6 is a front view illustrating the grip lock mechanism in a state in which the grip is locked according to the Embodiment 1.

FIG. 7 is a front view illustrating the grip lock mechanism in a state in which the lock of the grip is released according to the Embodiment 1.

FIG. 8 is a front view illustrating a rotatable member according to the Embodiment 1.

FIG. 9 is a perspective view illustrating the rotatable member according to the Embodiment 1.

### DESCRIPTION OF THE EMBODIMENTS

Hereinafter, Embodiments for carrying out the present invention will be described with reference to the drawings. In the present Embodiment, a case in which an inkjet recording system 1 is employed as an image forming system will be described.

### [Inkjet Recording System]

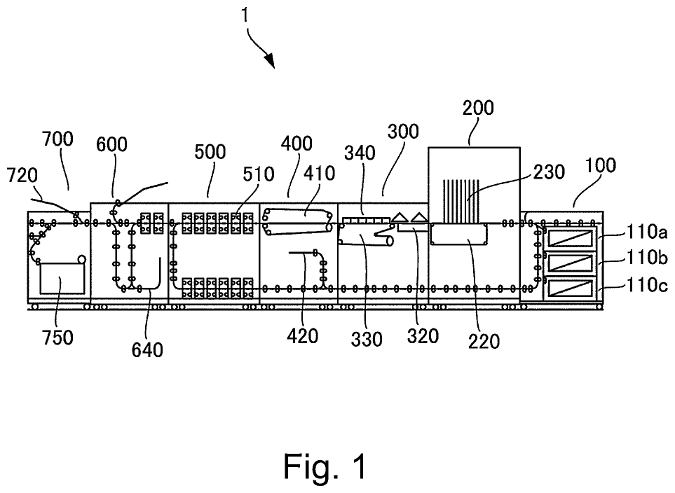

First, an overall configuration of the inkjet recording system 1 according to an Embodiment 1 will be described using FIG. 1. FIG. 1 is a schematic view illustrating the inkjet recording system 1 according to the present Embodiment. The inkjet recording system 1 as an image forming system is an inkjet recording system of a cut sheet type which produces a recorded product in which an ink image is formed on a sheet S using two liquids of reaction fluid and ink. As shown in FIG. 1, the inkjet recording system 1 is constituted by a feeding module 100, a printing module 200, a drying module 300, a fixing module 400, a cooling module 500, a reversing module 600 and a discharging module 700. The sheet S in a cut paper shape supplied from the feeding module 100 is conveyed along a conveyance passage, processed by each module, and discharged by the discharging module 700 as a sheet stacking device.

The feeding module 100 is provided with three storages 110a, 110b and 110c as sheet accommodating portions which accommodate the sheets S. Each of the storages 110a, 110b and 110c is configured to be drawable toward a front side of the device. The sheet S is fed one by one by a separating belt and a conveyance roller in each of the storages 110a, 110b and 110c, and are conveyed to the printing module 200. Incidentally, a number of the storages 110a, 110b and 110c is not limited to three, but the system may be configured to include one or two, or four or more storages. In addition, one feeding module 100 is provided in FIG. 1, however, a separate feeding module may be disposed on an upstream side (right side) of the feeding module 100 in a feeding direction.

The printing module 200 as an image forming apparatus is provided with a pre image registration correcting portion, a printing belt unit 220 and a recording portion 230. A tilt and a position of the sheet S conveyed from the feeding module 100 is corrected by the pre image registration correcting portion and conveyed to the printing belt unit 220. The recording portion 230 is disposed in a position opposite to the printing belt unit 220 with respect to the conveyance passage. The recording portion 230 is an image forming portion which forms an image by performing a recording process (printing) on the sheet S with recording heads from above with respect to the conveyed sheet S. A plurality of the recording heads are lined up along a conveyance direction. In the present Embodiment, a total of five recording heads of line type corresponding to four colors of Y (yellow), M (magenta), C (cyan) and Bk (black), as well as reaction fluid are provided. Incidentally, a number of colors and recording heads is not limited to five. As an inkjet method, a method using a heat-generating element, a method using a piezoelectric element, a method using an electrostatic element, a method using a MEMS element, etc. can be employed. The ink of each color is supplied from an ink tank to the recording heads via an ink tube. The sheet S printed in the recording portion 230 is conveyed while ensuring clearance with the recording heads by being suctioned and conveyed by the printing belt unit 220. With respect to the sheet S printed in the recording portion 230, misalignment and color density of the image formed on the sheet S is detected by an in-line scanner disposed on a downstream side of the recording portion in the sheet conveyance direction. The detection result is used for correction of the printing image.

The drying module 300 is provided with a decoupling portion 320, a drying belt unit 330 and a hot air blowing portion 340, reduces a liquid content contained in the ink applied on the sheet in the recording portion 230 of the printing module 200, and enhances fixing performance of the ink to the sheet S. The sheet S printed in the recording portion 230 of the printing module 200 is conveyed to the decoupling portion 320, which is disposed on an upstream side of the drying module 300 in the sheet conveyance direction. The decoupling portion 320 can convey the sheet S with wind pressure from above and friction of a belt, and prevents misalignment of the sheet S on the printing belt unit 220, which forms the ink image, by weakly holding and conveying the sheet S on the belt. The drying belt unit 330 is disposed below the belt and the hot air blowing portion 340 is disposed above the belt, opposing each other across the belt. The sheet S conveyed from the decoupling portion 320 is suctioned and conveyed by the drying belt unit 330, and at the same time, a surface onto which the ink is applied is dried by receiving hot air from the hot air blowing portion 340. Incidentally, with regard to a drying type, in addition to a type applying the hot air, it may be configured by combining a type irradiating electromagnetic waves (such as ultraviolet or infrared rays) onto the surface of the sheet S and a conduction heat transfer type by a contact of a heat generating element.

The fixing module 400 is provided with a fixing belt unit 410. The fixing belt unit 410 is provided with an upper belt unit and a lower belt unit, and fixes the ink to the sheet S by passing the sheet S conveyed from the drying module 300 between the heated upper belt unit and the lower belt unit.

The cooling module 500 is provided with a plurality of cooling portions 510, and cools the hot sheet S conveyed from the fixing module 400. The cooling portion 510 is configured to cool the sheet S by sucking outside air into a cooling box with a fan, increasing pressure in the cooling box, and blowing air blown from a nozzle formed on a conveyance guide to the sheet S. The cooling portion 510 is disposed on both an upside and a downside with respect to the conveyance passage and cools the sheet S from both sides.

In addition, the cooling module 500 is also provided with a conveyance passage switching portion, which can switch the conveyance passage of the sheet S depending on a case in which the sheet S is conveyed to the reversing module 600 and a case in which the sheet S is conveyed to a double-side conveyance passage, which is used upon a double-side printing. During the double-side printing, the sheet S is conveyed to a conveyance passage in a lower portion of the cooling module 500. In this case, the sheet S is further conveyed along the double-side conveyance passage from the cooling module 500 through the fixing module 400, the drying module 300, the printing module 200 and the feeding module 100. In the double-side conveyance passage of the fixing module 400, a first reversing portion 420 is provided to reverse a front and back of the sheet S. The sheet S is then conveyed again from the feeding module 100 to the pre image registration correcting portion of the printing module 200, the printing belt unit 220 and the recording portion 230, and is printed in the recording portion 230.

The reversing module 600 is provided with a second reversing portion 640, and can reverse the front and back of the conveyed sheet and change front and back orientation of the discharged sheet. The discharging module 700 is provided with a top tray 720 and a stacking portion 750, and regulates and stacks the sheets S conveyed from the reversing module 600 on the top tray 720 or the stacking portion 750, or discharges the sheet S to an external tray, etc.

### [Configuration of the Feeding Module]

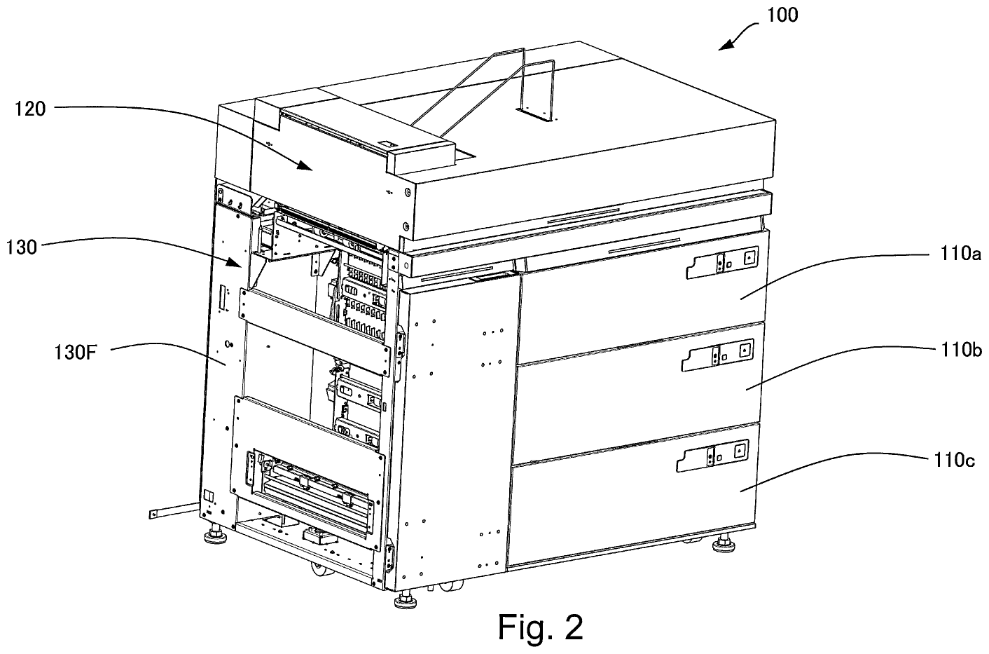

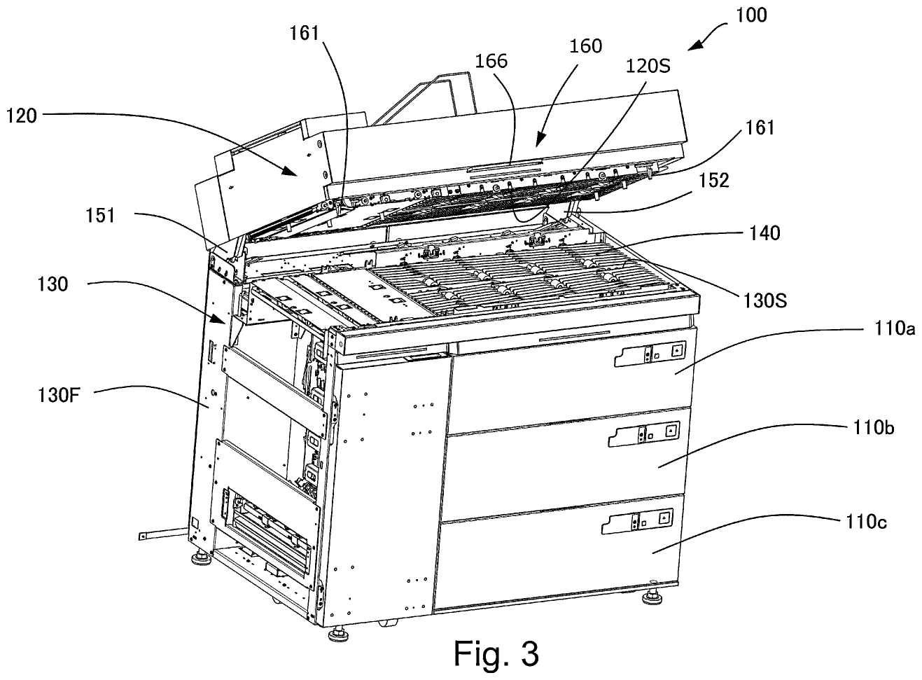

Next, detailed configuration of the feeding module 100 will be described using FIG. 2 and FIG. 3. FIG. 2 is a perspective view illustrating the feeding module in a state in which an upper door unit is closed according to the present Embodiment. FIG. 3 is a perspective view illustrating the feeding module in a state in which the upper door unit is opened according to the present Embodiment.

As shown in FIG. 2 and FIG. 3, the feeding module 100 is provided with a main body unit 130 and an upper door unit 120, which is disposed above the main body unit 130 and is openable and closable in a vertical direction with respect to the main body unit 130. In the main body unit 130, the storages 110a through 110c are disposed in a stacked manner in the vertical direction and supported by a main body frame 130F. As shown in FIG. 3, above the main body unit 130, a left side hinge 151 and

a right side hinge 152, which are disposed upstream and downstream in the sheet conveyance direction, in other words, disposed on left and right as viewed from a front of the unit, are disposed. By the left side hinge 151 and the right side hinge 152, the upper door unit 120 is connected so as to be rotatable in the vertical direction with respect to the main body unit 130.

As shown in FIG. 3, an upper surface 130S of the main body unit 130 forms a lower surface as a first surface of a horizontal conveyance passage 140 as a conveyance passage which conveys the sheet, and a lower surface 120S of the upper door unit 120 forms an upper surface as a second surface of the horizontal conveyance passage 140. That is, the upper door unit 120 is disposed so as to be openable and closable to a closed position which is closed to the main body unit 130 and an open position which is opened to the main body unit 130, forms the horizontal conveyance passage 140 in the closed position, and opens the horizontal conveyance passage 140 in the open position. By opening the horizontal conveyance passage 140 in this manner, it becomes possible to perform maintenance work in the horizontal conveyance passage 140 and jam clearance work.

### [Unit Lock Mechanism]

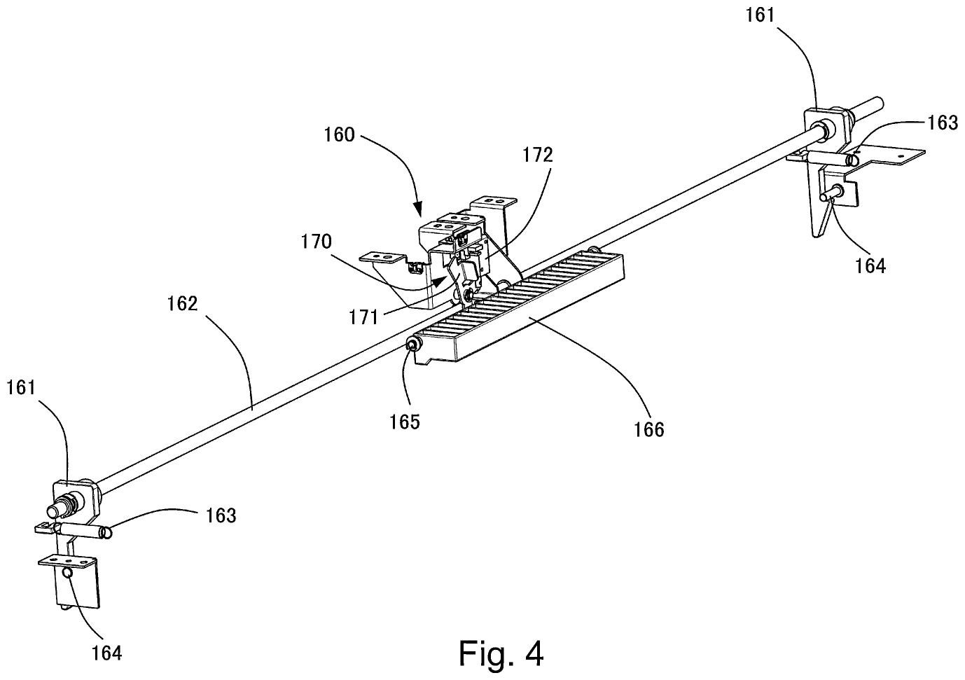

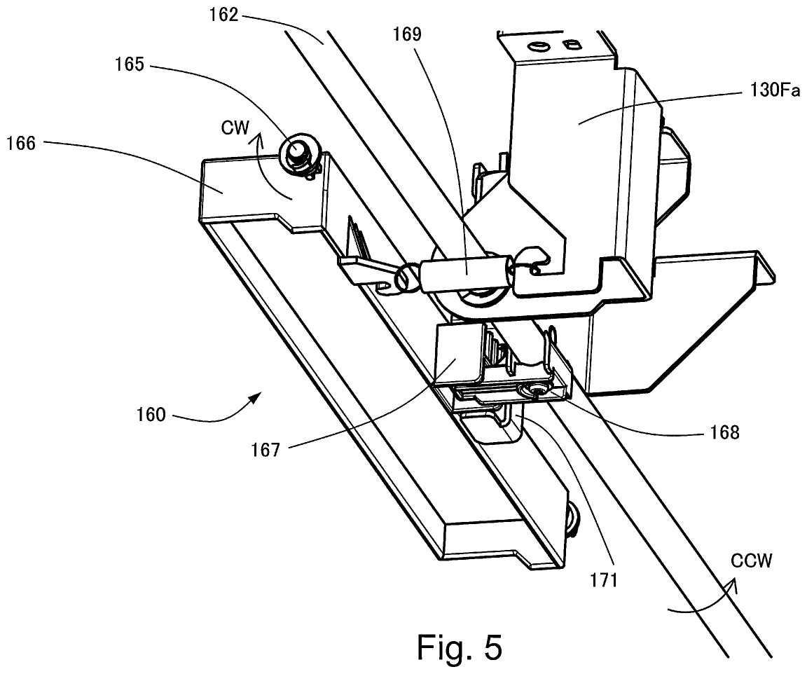

Next, a unit lock mechanism 160 which locks the upper door unit 120 in the closed position will be described using FIG. 3, FIG. 4 and FIG. 5. FIG. 3 is a perspective view illustrating the feeding module in a state in which the upper door unit is opened according to the present Embodiment. FIG. 4 is a perspective view illustrating the unit lock mechanism of the upper door unit according to the present Embodiment. FIG. 5 is a perspective view illustrating a grip and a grip lock mechanism of the unit lock mechanism according to the present Embodiment.

As shown in FIG. 3 and FIG. 4, in the unit lock mechanism 160, in the vicinity of a center in a horizontal direction of the upper door unit 120, a grip 166 as an operating portion, for example, for a user to operate to release a lock of the upper door unit 120 in the closed position is disposed. At both left and right end portions of the grip 166, grip rotary shafts 165, which serve as rotation centers of the grip 166, are provided.

As shown in FIG. 5, in the unit lock mechanism 160, on a back side of the grip 166 in the upper door unit 120, a rotation transmitting portion 167 to transmit a rotational operation of the grip 166 to a latch rotational shaft 162 is provided. For example, when the grip 166 is pushed upward by the user, the grip 166 is rotated clockwise (in a direction of an arrow CW) and the rotation transmitting portion 167 is rotated in a downward direction. And when the rotation transmitting portion 167 is rotated, the rotation transmitting portion 167 contacts and presses the rotation transmitted portion 168 fixed to the latch rotational shaft 162, causing the latch rotational shaft 162 to be rotated counterclockwise (in a direction of an arrow CCW). Because of this, as shown in FIG. 4, latch claws 161 provided on both left and right end portions of the latch rotational shaft 162 are rotated, and by engagement between latch fixing shafts 164 and the latch claws 161 being released, the lock of the upper door unit 120 is released. As a result, about a rotation center of the left side hinge 151 and the right side hinge 152 as a center, the upper door unit 120 becomes openable and closable to the main body unit 130. In other words, it is configured that, by operating the grip 166, the lock of the unit lock mechanism 160 can be released.

Incidentally, in the unit lock mechanism 160, a latch urging spring 163 to urge the latch claw 161 to a position engaging the latch fixing shaft 164 is provided between the main body frame 130F (see FIG. 3) and the latch claw 161 in FIG. 4. In addition, in the unit lock mechanism 160, a grip urging spring 169 to urge the grip 166 toward an initial position is provided between a bracket 130Fa, which is fixed to the main body frame 130F, and the grip 166.

### [Configuration of the Grip Lock Mechanism]

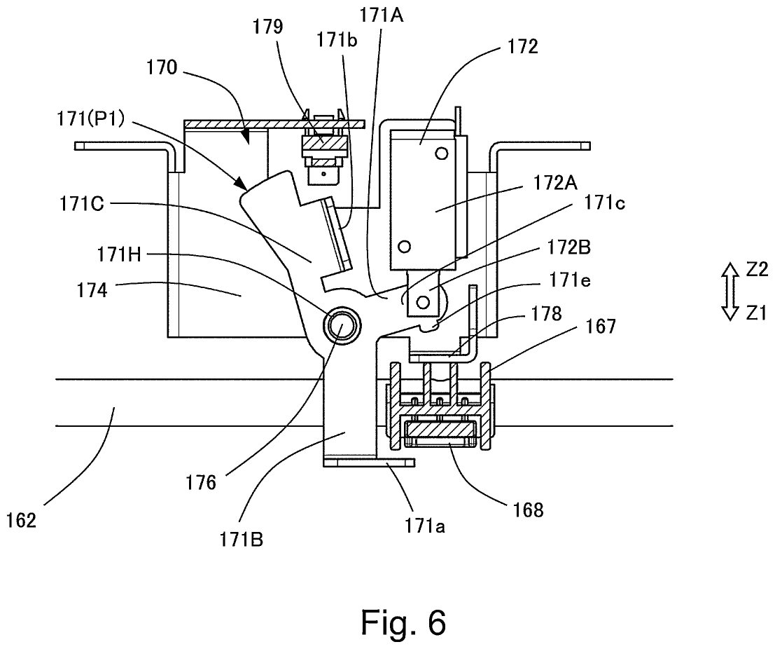

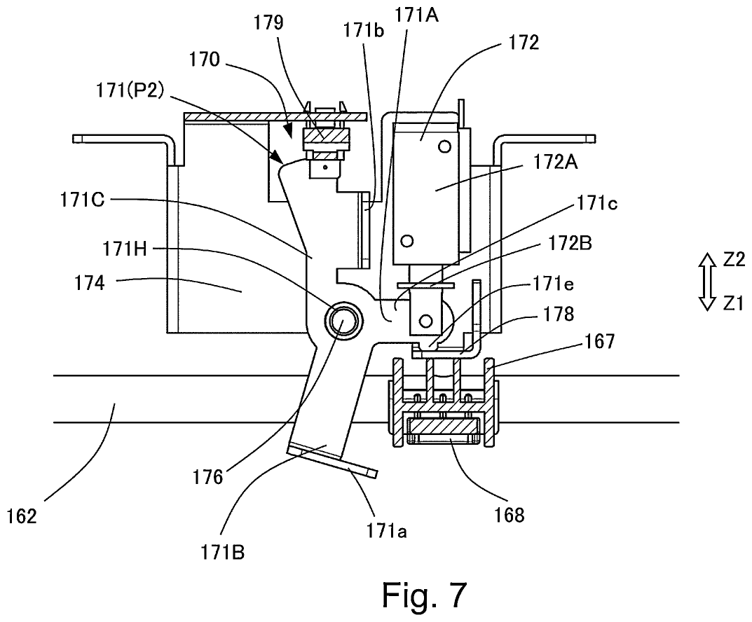

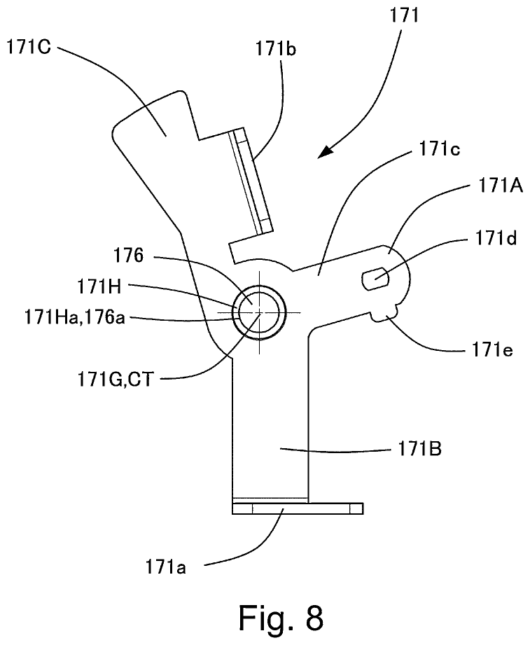

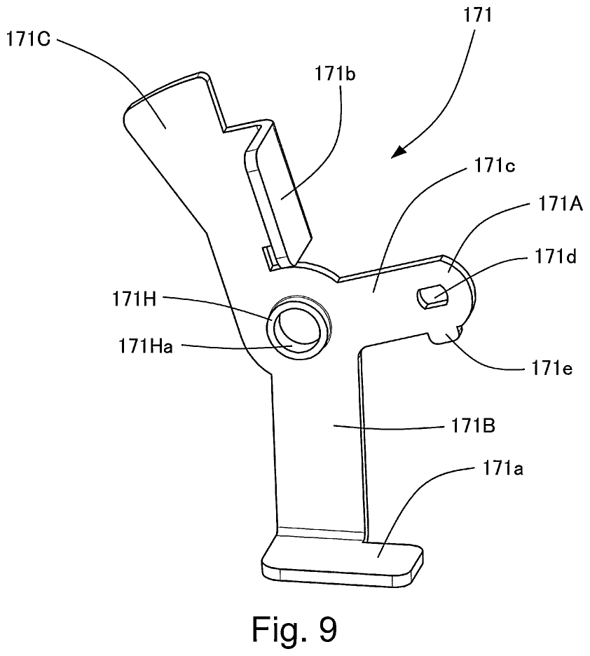

Next, a grip lock mechanism 170 will be described using FIG. 5, FIG. 6, FIG. 7, FIG. 8 and FIG. 9. The grip lock mechanism 170 is a configuration which further locks a locking state of the unit lock mechanism 160 by locking the rotation of the grip 166 of the unit lock mechanism 160 (making the operation of the grip 166 inoperatable). Incidentally, FIG. 6 is a front view illustrating the grip lock mechanism in a state in which the grip is locked according to the present Embodiment. FIG. 7 is a front view illustrating the grip lock mechanism in a state in which the lock of the grip is released according to the present Embodiment. FIG. 8 is a front view illustrating a rotatable member according to the present Embodiment. FIG. 9 is a perspective view illustrating the rotatable member according to the present Embodiment.

As shown in FIG. 5, the grip lock mechanism 170 is disposed on the back side of the rotation transmitting portion 167 of the grip 166. As shown in FIG. 6 and FIG. 7, the grip lock mechanism 170 is provided with a solenoid 172, which outputs driving force as a driving portion, and a rotatable member 171, which is provided so as to be rotatable about a center CT of a center shaft 176 (see FIG. 8) as a rotation center by being connected to the solenoid 172. In addition, the grip lock mechanism 170 is provided with a supporting stand 174 which supports the rotatable member 171 via the solenoid 172 and the center shaft 176, and a position detecting sensor 179 as a rotational position detecting portion, which detects a position in a rotational direction (posture) of the rotatable member 171.

The solenoid 172 is constituted by a movable iron core 172B and an electromagnetic driving portion 172A which pulls the movable iron core 172B upward in a direction of an arrow Z2 by magnetic force generated by supplied electrical power. On the other hand, as shown in FIG. 8 and FIG. 9, the rotatable member 171 is provided with, as an overview, an engaging hole 171H and three of a first arm portion 171A, a second arm portion 171B and a third arm portion 171C, which is disposed so as to extend to an outer diameter from the engaging hole 171H. As shown in FIG. 6, FIG. 7 and FIG. 8, in the engaging hole 171H, a center shaft 176 is disposed on an inner diameter side, and the center shaft 176 is integrally engaged (connected to) the rotatable member 171 by the center shaft 176 being fitted into the engaging hole 171H. Incidentally, the center shaft 176 is rotatably supported with respect to the supporting stand 174 freely.

As shown in FIG. 8 and FIG. 9, in the first arm portion 171A of the rotatable member 171, a connecting hole 171d is formed. As shown in FIG. 6 and FIG. 7, the solenoid 172 and the rotatable member 171 are connected by the movable iron core 172B being drivably connected to the connecting hole 171d. That is, the first arm portion 171A has a function to drivably connect the rotatable member 171 and the solenoid 172.

In addition, as shown in FIG. 8 and FIG. 9, in a tip on the outer diameter side of the second arm portion 171B, a lock restricting portion 171a, which can enter below the rotation transmitting portion 167 and a rotation transmitted portion 168 described in detail later, is folded and formed. With this, the second arm portion 171B has a function to lock the rotation of the grip 166.

In addition, the third arm portion 171C is formed so as to function as a flag member of the position detecting sensor 179. That is, the position detecting sensor 179 is constituted by, for example, an optical sensor, and is turned OFF when the third arm portion 171C shields light thereof and turned ON when the third arm portion 171C is separated therefrom. That is, the third arm portion 171C has a functions as a flag for the position detecting sensor 179.

### [Operation of the Grip Lock Mechanism]

Next, operation of the grip lock mechanism 170 will be described using FIG. 6 and FIG. 7. In the solenoid 172, electrical current is applied to a coil by the electrical power being supplied to the electromagnetic driving portion 172A by a control portion. Then, the magnetic force is generated in the electromagnetic driving portion 172A, and as shown in FIG. 6, the electromagnetic driving portion 172A is driven and moved so as to pull the movable iron core 172B upward indicated by the arrow Z2. When the movable iron core 172B is pulled upward, the first arm portion 171A is pulled upward via the connecting hole 171d, and the rotatable member 171 is positioned in a first position P1 shown in FIG. 6. Incidentally, when the rotatable member 171 is positioned in the first position P1, the third arm portion 171C, which serves as the flag member, is separated from the position detecting sensor 179, and the position detecting sensor 179 is turned ON to detect that the rotatable member 171 is in the first position P1.

In a state in which the rotatable member 171 is positioned in the first position P1, the lock restricting portion 171a formed on the tip of the second arm portion 171B enters so as to get into downside of the rotation transmitting portion 167 and the rotation transmitted portion 168 (see FIG. 5). Then, for example, even if the user tries to operate the grip 166, the rotation transmitting portion 167 and the rotation transmitted portion 168 are restricted (inhibited) so as not to be rotated downward by the lock restricting portion 171a. As a result, the grip 166 comes to be in an unrotatable state (locked state of the unit lock mechanism 160), i.e., the grip 166 is locked inoperatably. Therefore, the rotation of the grip 166 of the unit lock mechanism 160 is locked by the grip lock mechanism 170, i.e., releasing the lock of the upper door unit 120 is prevented.

On the other hand, in the solenoid 172, when the electrical power to the electromagnetic driving portion 172A is not supplied by the control portion, the magnetic force in the electromagnetic driving portion 172A is not generated, and as shown in FIG. 7, the movable iron core 172B is fallen by its own weight and moves below as indicated by an arrow Z1. When the movable iron core 172B moves downward, the first arm portion 171A is moved downward via the connecting hole 171d by being subjected to influence of moment caused by own weight of the movable iron core 172B. Therefore, the rotatable member 171 is rotated about the center shaft 176 as a center from the first position P1 shown in FIG. 6 to a second position P2 shown in FIG. 7. Incidentally, when the rotatable member 171 is in the second position P2, the third arm portion 171C, which serves as the flag member, shields the light of the position detecting sensor 179, and the position detecting sensor 179 is turned OFF to detect that the rotatable member 171 is in the second position P2.

In a state in which the rotatable member 171 is positioned in the second position P2, the lock restricting portion 171a formed on the tip of the second arm portion 171B is retracted from the downside of the rotation transmitting portion 167 and the rotation transmitted portion 168. As a result, the grip 166 comes to be in a rotatable (operatable) state (a state in which the lock of the unit lock mechanism 160 is released). In this state, for example, when the user operates the grip 166, the grip 166 is rotated since the rotation transmitting portion 167 and the rotation transmitted portion 168 are not restricted (inhibited) by the lock restricting portion 171a. Therefore, the latch rotational shaft 162 is rotated by the rotation transmitting portion 167 and the rotation transmitted portion 168 being rotated, and the engagement between the latch fixing shaft 164 and the latch claw 161 is released as described above, i.e., the lock of the upper door unit 120 is released.

Incidentally, in the present Embodiment, the solenoid 172 is disposed so that the movable iron core 172B is movable in the vertical direction, and the electromagnetic driving portion 172A of the solenoid 172 is configured so as to pull the movable iron core 172B upward by the magnetic force. As a result, when the electrical power is supplied to the electromagnetic driving portion 172A, the rotation of the grip 166 is locked by the grip lock mechanism 170, and when the electrical power is not supplied to the electromagnetic driving portion 172A, the lock of the rotation of the grip 166 is released by the grip lock mechanism 170. Therefore, it is configured so that the lock of the upper door unit 120 can be released upon occurrence of electrical power cut off such as electrical power outage, or when the power is turned OFF, and it becomes possible to perform the maintenance work in the horizontal conveyance passage 140 and the jam clearance work.

### [Gap Between an Abutting Portion of the Supporting Stand and the Movable Iron Core]

As described above, the grip lock mechanism 170 is supported by the supporting stand 174, and to the supporting stand 174, an abutting portion 178 is provided below the solenoid 172. In addition, the first arm portion 171A of the rotatable member 171 is formed so as to include an arm main body 171c and a contacting portion 171e, which is formed so as to project downward from the arm main body 171c.

As described above, when the electrical power is not supplied to the electromagnetic driving portion 172A, as shown in FIG. 7, the rotatable member 171 rotates from the first position P1 to the second position P2. At this time, the contacting portion 171e, which is provided to the first arm portion 171A, is in contact with the abutting portion 178 as a positioning portion, which is provided to the supporting stand 174, and the rotatable member 171 is positioned in the second position P2. As a result, the movable iron core 172B of the solenoid 172 stops against the abutting portion 178 with a gap of a predetermined distance. That is, for the movable iron core 172B, if the movable iron core 172B is in contact with or coming too close to the abutting portion 178 of the supporting stand 174, which is constituted by magnetic material such as iron, magnetic flux escapes from the movable iron core 172B to the abutting portion 178, therefore the driving force of the solenoid 172 by the magnetic force is reduced. In the present Embodiment, by the contacting portion 171e being in contact with the abutting portion 178, the movable iron core 172B and the abutting portion 178 are prevented from approaching each other with keeping the predetermined distance, and it becomes possible to prevent the driving force of the solenoid 172 from being reduced.

### [Material of the Rotatable Member]

In the present Embodiment, even to the rotatable member 171, which is connected to the movable iron core 172B via the first arm portion 171A, in order to prevent the magnetic flux from escaping, the rotatable member 171 is formed of non-magnetic material. Since the rotatable member 171 forms the lock restricting portion 171a at the tip of the second arm portion 171B, it is necessary to use strong material as material for the rotatable member 171. For this reason, as the material for the rotatable member 171, austenitic stainless steel is used, which is non-magnetic metallic material. By this, it becomes possible to prevent the magnetic flux of the solenoid 172 from escaping to the rotatable member 171 and to prevent the driving force of the solenoid 172 from being reduced.

### [Position of the Center of Gravity of the Rotatable Member]

Next, a position of the center of gravity 171G of the rotatable member 171 will be described using FIG. 8 and FIG. 9. As shown in FIG. 8, in the rotatable member 171, the engaging hole 171H, which the center shaft 176 is penetrated through and engaged with (fitted into), is formed. And an outer diameter surface 176a of the center shaft 176 fits into an inner diameter surface 171Ha of the engaging hole 171H, and the center shaft 176 and the rotatable member 171 are configured to rotate integrally about the center CT of the center shaft 176 as the rotation center. Incidentally, it may be configured that the center shaft 176 does not rotate, but the engaging hole 171H of the rotatable member 171 rotates with sliding against the outer diameter surface 176a of the center shaft 176.

And the position of the center of gravity 171G of the rotatable member 171 according to the present Embodiment is designed to be on the inner diameter side of the inner diameter surface 171Ha of the engaging hole 171H as viewed along an axial direction of the center shaft 176. More preferably, the position of the center of gravity 171G is designed to be approximately in the same position as the center CT of the engaging hole 171H and the center shaft 176. As a result, when the rotatable member 171 rotates, a moving range of the position of the center of gravity 171G is within a range of the inner diameter surface 171Ha of the engaging hole 171H, and the effect of the moment (rotation moment) caused by own weight of the rotatable member 171 can be minimized. As a result, it becomes possible to minimize required driving force performance of the solenoid 172, to downsize the solenoid 172, and to reduce power consumption (current value) applied to the solenoid 172.

Incidentally, in the present Embodiment, the configuration in which the position of the center of gravity 171G of the rotatable member 171 is designed to be on the inner diameter side of the inner diameter surface 171Ha of the engaging hole 171H as viewed along the axial direction is described. However, for example, it may be configured that the center shaft 176 is constituted by a so-called caulking shaft and is caulked into the engaging hole 171H of the rotatable member 171. In this case, the inner diameter surface 171Ha of the engaging hole 171H is smaller than the outer diameter surface of the center shaft 176. Therefore, for example, considering a case in which the center shaft 176 is caulked into the engaging hole 171H, it may be configured that the position of the center of gravity 171G of the rotatable member 171 is designed to be on the inner diameter side than an outer peripheral surface of a caulked portion, which is expanded in diameter, of the center shaft 176 as viewed along the axial direction. By this as well, it becomes possible to minimize the effect of the moment caused by own weight of the rotatable member 171, and minimize the required driving force performance of the solenoid 172.

### [Balance Adjusting Portion]

Next, a balance adjusting portion 171b as an adjusted shape portion for adjusting the position of the center of gravity 171G of the rotatable member 171 will be described using FIG. 8 and FIG. 9. The closer the position of the center of gravity 171G of the rotatable member 171 is to the center CT of the engaging hole 171H and the center shaft 176, the smaller the moment of the rotatable member 171 will be, and the required driving force performance of the solenoid 172 can be reduced. However, shapes of the first arm portion 171A, the second arm portion 171B and the third arm portion 171C must be shapes to achieve the functions thereof, and if they are designed considering only the shapes to achieve the functions thereof, there is a possibility that the position of the center of gravity 171G may be away from the center CT.

Therefore, in the rotatable member 171 according to the present Embodiment, the balance adjusting portion 171b for adjusting the position of the center of gravity 171G is formed. The balance adjusting portion 171b is formed in the third arm portion 171C in the present Embodiment, and a distance (position) of the balance adjusting portion 171b from the center CT and a shape (e.g., wall thickness) thereof are adjusted so that the position of the center of gravity 171G is closer to the center CT. In other words, by providing the balance adjusting portion 171b, the position of the center of gravity 171G of the rotatable member 171 can be designed to be in the center CT of the engaging hole 171H and the center shaft 176.

Incidentally, in the present Embodiment, the configuration in which the rotatable member 171 includes the shape of the balance adjusting portion 171b is described, however, it is not limited thereto. For example, it may be a configuration in which a weight is attached as a separate component as a balance adjusting portion, or a recessed portion or a hole is provided in the rotatable member 171 to reduce the weight. In addition, a position in which the balance adjusting portion is provided is not limited to the third arm portion 171C, but can be any position of the rotatable member 171. In particular, in a case in which a weight is added to the position of the center of gravity of the rotatable member 171 without the balance adjusting portion, the balance adjusting portion is provided on an opposite side across the center CT, and in a case in which a weight is reduced, the balance adjusting portion is provided on a side in which the center CT is located.

### POSSIBILITY FOR OTHER EMBODIMENTS

Incidentally, in the present Embodiment described above, the configuration in which the rotatable member 171 includes three arm portions of the first arm portion 171A, the second arm portion 171B and the third arm portion 171C is described. However, it is not limited thereto but the rotatable member may have two arm portions or four or more arm portions. In particular, if the position detecting sensor 179 is configured to detect the first arm portion 171A or the second arm portion 171B as the flag member, it becomes possible to make the third arm portion unnecessary.

In addition, in the present Embodiment, the configuration in which the solenoid 172 is disposed so that an operating direction of the movable iron core 172B is in the vertical direction, and the electromagnetic driving portion 172A pulls the movable iron core 172B upward when the electrical power is supplied thereto is described. However, it is not limited thereto but a disposed direction of the solenoid 172 can be any direction, and in particular, it may be a configuration in which the electromagnetic driving portion 172A pushing the movable iron core 172B upward when the electrical power is supplied thereto. Furthermore, in the present Embodiment, the configuration in which the movable iron core 172B moves downward by its own weight when the electrical power is not supplied, however, it is not limited thereto but it may be a configuration in which the movable iron core 172B is moved by an urging member such as a spring when the electrical power is not supplied thereto. In this case, the smaller urging force of the urging member is, the more downsizing of the solenoid 172 becomes possible.

In addition, in the present Embodiment, the configuration in which the rotatable member 171 is made of a non-magnetic metal material is described, however, it is not limited thereto but any material can be used. For example, if magnetic material is used as the material for the rotatable member 171, a member which serves as a magnetic shield may be interposed between the solenoid 172 and the rotatable member 171. Furthermore, it is not limited to the metal material but may be a configuration in which the rotatable member 171 is made of resin material, etc.

In addition, in the present Embodiment, the configuration in which, as an opening/closing member which opens and closes to the apparatus main body, by rotating the upper door unit 120 in the vertical direction, the horizontal conveyance passage 140 is opened is described, however, it is not limited thereto. For example, a cover, a door, a unit, etc., which opens and closes to open the conveyance passage, to perform maintenance on internal components, to replace consumables (e.g., ink), etc., can be considered as an opening/closing member. In addition, an opening/closing direction of the opening/closing members is not limited to the vertical direction, but the opening/closing direction as well can be any direction such as a configuration of being opened and closed about a shaft of the vertical direction in a side surface.

In addition, in the present Embodiment, the configuration in which the lock restricting portion 171a of the second arm portion 171B of the rotatable member 171 locks or releases the lock of the rotation of the grip 166 of the unit lock mechanism 160 is described. However, it is not limited thereto but, for example, it may be a configuration in which the rotatable member 171 directly locks or releases the lock of the opening/closing member which is opened and closed to the main body.

In addition, in the present Embodiment, the configuration in which, the upper door unit 120 is locked in the closed position by the unit lock mechanism 160 is described, however, the unit lock mechanism 160 is an example and can be of any structure.

In addition, in the present Embodiment, as an example of the sheet conveyance device, the configuration in which the grip lock mechanism 170 is used in the feeding module 100 is described. However, it is not limited thereto but can be any device as long as the device conveys the sheet, for example, a processing device such as a feeding deck, an image forming apparatus, a finisher, a hole puncher, a bookbinding or other processing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-127864 filed on Aug. 4, 2023, which is hereby incorporated by reference herein in its entirety.

What is claimed is:

1. A sheet conveyance device for conveying a sheet, the sheet conveyance device comprising:
a center shaft;
a driving portion configured to output a driving force; and
a rotatable member provided with an engaging hole configured to engage with the center shaft, a drive coupling portion disposed on an outer diameter side of the engaging hole and coupled to the driving portion, and a restricting portion disposed on the outer diameter side of the engaging hole and configured to restrict movement of a moving member,
wherein the rotatable member changes a position of the restricting portion by being rotated between a first position and a second position rotated from the first position about the center shaft by driving of the driving portion, and
wherein as viewed in an axial direction of the center shaft, a position of a center of gravity of the rotatable member is positioned in an inner diameter side of an inner diameter surface of the engaging hole.

2. A sheet conveyance device according to claim 1, wherein as viewed in the axial direction, the position of the center of gravity of the rotatable member is positioned in the inner diameter side of an outer diameter surface of the center shaft.

3. A sheet conveyance device according to claim 1, wherein as viewed in the axial direction, the position of the center of gravity of the rotatable member is substantially the same position as a center of the engaging hole.

4. A sheet conveyance device according to claim 1, wherein the rotatable member includes an adjusted shape portion formed into a shape such that the position of the center of gravity is adjusted.

5. A sheet conveyance device according to claim 1, wherein the rotatable member includes a detected portion disposed on the outer diameter side of the engaging hole, and
wherein the sheet conveyance device includes a sensor configured to detect a position of the detected portion.

6. A sheet conveyance device according to claim 1, wherein the driving portion includes a movable iron core and an electromagnetic driving portion configured to drive the movable iron core by a magnetic force generated by a supplied electrical power.

7. A sheet conveyance device according to claim 6, wherein the rotatable member includes a positioning portion configured to position the rotatable member to the second position by contacting the rotatable member when the rotatable member is rotated from the first position toward the second position, and
wherein the drive coupling portion includes a contacting portion formed so as to project toward a rotational direction of the rotatable member and configured to contact the positioning portion in the second position.

8. A sheet conveyance device according to claim 6, wherein the rotatable member is formed of a nonmagnetic metallic material.

9. A sheet conveyance device according to claim 8, wherein the driving portion is disposed such that the movable iron core is movable in a vertical direction, and
wherein the electromagnetic driving portion pulls up upward the movable iron core by the magnetic force.

10. A sheet conveyance device for conveying a sheet, the sheet conveyance device comprising:
a center shaft;
a driving portion configured to output a driving force; and
a rotatable member provided with an engaging hole configured to engage with the center shaft, a drive coupling portion disposed on an outer diameter side of the engaging hole and coupled to the driving portion, and a restricting portion disposed on the outer diameter side of the engaging hole and configured to restrict movement of a moving member,
wherein the rotatable member changes a position of the restricting portion by being rotated between a first position and a second position rotated from the first position about the center shaft by driving of the driving portion, and
wherein as viewed in an axial direction of the center shaft, a position of a center of gravity of the rotatable member is positioned in an inner diameter side of an outer diameter surface of the center shaft.

11. A sheet conveyance device according to claim 10, further comprising:
a first unit including a first surface forming a conveyance passage through which the sheet is conveyed;
a second unit openably and closably disposed between a closed position closed to the first unit and an open position opened from the closed position, and including a second surface opposing the first surface in the closed position and forming the conveyance passage; and
a unit lock mechanism including an operating portion moving the rotatable member, capable of locking the second unit to the closed position and capable of releasing a lock of the second unit in the closed position by the operating portion being operated,
wherein the restricting portion inoperatably locks the operating portion by restricting the movement of the rotatable member in a case in which the rotating member is in the first position, and enable operation of the operating portion in a case in which the rotating member is in the second position.

12. A sheet conveyance device according to claim 11, wherein the first unit includes a sheet accommodating portion configured to accommodate and support a plurality of sheets and feed the sheet by conveying the sheet from the sheet accommodating portion.

13. A sheet conveyance device according to claim 10, wherein the rotatable member includes a detected portion disposed on the outer diameter side of the engaging hole, and
wherein the sheet conveyance device includes a sensor configured to detect a position of the detected portion.

14. An image forming apparatus comprising:
a sheet conveyance device according to claim 11; and
an image forming portion configured to form an image on the sheet.
